(19) United States
(12) Patent Application Publication
(10) Pub. No.: US 2007/0109132 A1
(43) Pub. Date: May 17, 2007

(54) RFID TAG DEVICE AND ARTICLES SHELF EQUIPPED WITH SAME

(75) Inventors: Kouichi Sano, Shizuoka-ken (JP); Nobuo Murofushi, Shizuoka-ken (JP); Takahiro Shimura, Shizuoka-ken (JP); Yasuhito Kiji, Shizuoka-ken (JP); Yasuo Matsumoto, Shizuoka-ken (JP)

Correspondence Address: DLA PIPER US LLP, P. O. BOX 9271, RESTON, VA, 20195, US

(73) Assignee: Toshiba TEC Kabushiki Kaisha, Tokyo (JP)

(21) Appl. No.: 11/555,762

(22) Filed: Nov. 2, 2006

(30) Foreign Application Priority Data
Nov. 11, 2005 (JP) 2005-327680

(51) Int. Cl. G08B 13/14

(52) U.S. Cl. 340/572.8; 340/572.7

(57) ABSTRACT

An RFID tag device includes an RFID tag having a directivity of maximum gain of electromagnetic waves therefrom in a specific direction and an RFID tag-supporting base supporting the RFID tag. The RFID tag-supporting base includes a first surface on which the RFID tag is attached and a second surface which is oppositely located with and is positioned not in parallel to the first surface to orient the maximum gain direction of the electromagnetic waves from the RFID tag toward a desired direction.

### BACKGROUND OF THE INVENTION

1. Field of the Invention

The present invention relates, in general, to an RFID (Radio Frequency Identification) tag device and, in particular, to the RFID tag device having a tag-supporting base on which an RFID tag is supported.

2. Description of the Related Art

RFID technology is used to carry out an inventory management or an article tracking or article location management and so on. In the RFID technology, RFID tags attached to articles, such as, e.g., books, packages, containers and so on, and an RFID tag reader are used and radio-communications are performed between the RFID tags and the RFID tag reader to read data stored in the RFID tags.

U.S. Pat. No. 7,040,532 discloses a data tracking system in which a plurality of wine barrels are stacked with a plurality of racks respectively located between the barrels in a vertical direction and a plurality of RFID tags are attached to the plurality of wine barrels respectively, data stored in each tag being read by an RFID tag reader to manage the location of specific barrel. In this prior art, an extendable shaft on which an RFID tag reader is attached at its tip is used to read data stored in the RFID tag of a wine barrel stacked at a higher location. The extendable shaft is extended to relatively take the RFID tag to be read into a readable area of the RFID tag reader each time RFID tag at a higher location is read. However, such operations are troublesome by an operator and equipment of extendable shaft and related constructions cause a cost increasing.

### SUMMARY OF THE INVENTION

Accordingly, it is an object of the present invention to easily read data of RFID tag without a troublesome operation.

To accomplish the above object, an RFID tag device includes an RFID tag having a directivity of maximum gain in a specific direction; and an RFID tag-supporting base configured to orient the maximum gain direction of the RFID tag toward a desired direction, the RFID tag-supporting base having a first surface on which the RFID tag is supported and a second surface which is oppositely located with and not in parallel to the first surface.

### BRIEF DESCRIPTION OF THE DRAWINGS

Other objects and advantages of this invention will become apparent and more readily appreciated from the following detailed description of the presently preferred exemplary embodiments of the invention taken in conjunction with the accompanying drawings wherein:

FIG. 1 is a view illustrating a construction of an RFID tag device according to one embodiment of the present invention;

FIG. 2 is a schematic view illustrating an articles shelf, in partly cutaway, using the RFID tags shown in FIG. 1;

FIG. 3 is a view illustrating a construction of an RFID tag device according to a second embodiment of the present invention;

FIG. 4 is a graph showing a relationship among a forwarding wave of electromagnetic waves, a reflected wave thereof by a reflection plate and a composite wave of the forwarding wave and the reflected wave in the second embodiment;

FIG. 5 is a graph illustrating a variation in a time-lapse of a composite waves in the second embodiment; and

FIG. 6 is a perspective view illustrating an RFID tag device of a third embodiment of the present invention.

### DETAILED DESCRIPTION OF THE INVENTION

Preferred embodiments of the present invention will now be described in more detail with reference to the accompanying drawings. However, the same numerals are applied to the similar elements in the drawings, and therefore, the detailed descriptions thereof are not repeated.

### First Embodiment

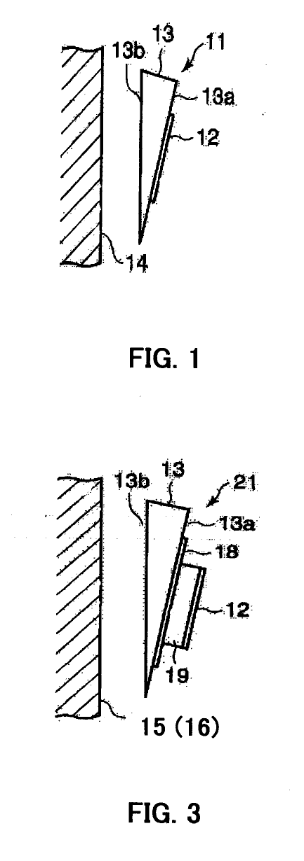

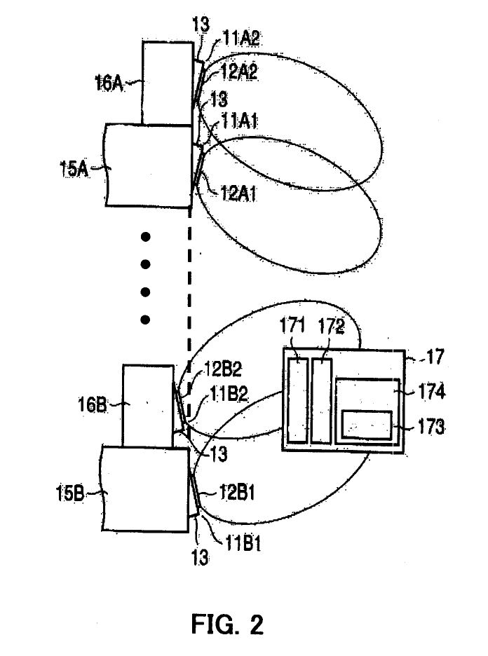

A first embodiment of the present invention will be described with reference to FIGS. 1 and 2. FIG. 1 is a sectional view indicating a first embodiment of the present invention and FIG. 2 is a view partially illustrating an articles shelf equipped with an RFID tag device.

As shown in FIG. 1, an RFID tag device 11 includes an RFID tag 12 and an RFID tag-supporting base 13 which supports the RFID tag 12. The RFID tag-supporting base 13 includes an RFID) tag supporting surface 13a (first surface) supporting the RFID tag 12 and an attaching surface 13b (second surface) being fixed to an article and/or a receiving surface (front surface) of an articles shelf described later. The supporting surface 13a and the attaching surface 13b are oppositely located with and are positioned not in parallel to one the other such that one of the edges of the supporting surface 13a and one of the edges of the attaching surface 13b are merged and each surface extends from the merged edge at a prescribed angle, in a triangular shape in section shown in FIG. 1.

The RFID tag 12 is a passive transponder, as is well known in the art, for example, and has a thin substrate on which an IC chip and an antenna connected to the IC chip are mounted. The IC chip has a memory storing an ID data and other information associated with an article to which the tag is attached and the antenna is arranged around the IC chip. In this embodiment, RFID tags of an active type that includes an own internal power source, e.g., battery, can also be used instead of the RFID tags of a passive type. In the RFID technology, an interrogator (RFID tag reader), also well known in the art, sends electromagnetic waves to the RFID tag to request a radio-communication therebetween and then the RFID tag generates power from the electromagnetic waves to wake-up the IC chip when the RFID tag receives the electromagnetic waves through the antenna. In response to the request signal (interrogation signal) from the interrogator, a predetermined handshake is carried out between the tag and the interrogator and then data, e.g., ID data, stored in the memory is sent from the tag to the interrogator by using a backscatter modulation. Such an RFID tag has a directivity of a maximum gain in a direction perpendicular to the substrate surface.

FIG. 2 shows a part of articles shelf on which articles are displayed or stored. The articles shelf includes a plurality of shelf plates in a vertical direction and each shelf plate has a receiving surface at its front surface. RFID tags are attached to the articles and the receiving surfaces of shelf plates at a same side, respectively. As shown in FIG. 2, an upper-most shelf plate 15A that an article 16A is displayed on its shelf-surface and a lower-most shelf plate 15B that an article 16B is displayed on its shelf-surface are only illustrated, for the purpose of simplicity. A handheld interrogator (RFID tag reader) 17 that transmits an interrogation signal with electromagnetic waves to RFID tags is also illustrated in FIG. 2.

A construction of the handheld interrogator 17 will be described. The interrogator 17 includes an antenna 171, a radio-communication section 172 and a control section 174 which has a memory 173. The control section 174 controls the radio-communication section 172 and the memory 173. The interrogator 171 transmits electromagnetic waves toward each RFID tag 12B1, 12B2 through the radio-communication section 172 and the antenna 171 and each RFID tag receives electromagnetic waves and generates power when each RFID tag enters into a readable area of the interrogator 17. Data, e.g., ID data stored in each RFID tag is then transmitted from each RFID tag to the interrogator and the transmitted data is stored in the memory 173 after a predetermined handshake is accomplished between the interrogator and each RFID tag.

As shown in FIG. 2, each shelf-surface of the plurality of shelf plates 15A, 15B has a horizontal level and the receiving surface on which RFID tag device 11A1, 11B1 is to be attached extends from the front edge of the shelf-surface of the shelf plate in a direction perpendicular to the horizontal level.

As shown in FIG. 2, when the RFID tag device 11A1 is attached to the upper-most shelf plate 15A, the attaching surface of the RFID tag-supporting base 13 is fixed on the receiving surface of the shelf plate 15A so that a maximum gain direction of electromagnetic waves radiated from the RFID tag device 11A1 is consistent with a diagonal-downward direction. A direction of the maximum gain of electromagnetic waves from the RFID tag device 11A2 attached to the article 16A is also oriented toward the same direction as the RFID tag device 11A1 described above.

In contrast to the above, when the RFID tag device 11B1 is attached to the lower-most shelf plate 15B, the attaching surface of the RFID tag-supporting base 13 is fixed on the receiving surface of the shelf plate 15B so that a maximum gain direction of electromagnetic waves radiated from the RFID tag device 11B1 is consistent with a diagonal-upward direction. A direction of the maximum gain of electromagnetic waves from the RFID tag device llB2 attached to the article 16B is also oriented toward the same direction as the RFID tag device 11AB described above.

On the other hand, when RFID tags are attached to shelf plates facing an operator between the upper-most and lower-most shelf plates 15A and 15B, RFID tag-supporting bases 13 shown in FIG. 1 are not used. An ordinary structured RFID tag-supporting bases that the RFID tag supporting surface 13a (first surface) supporting the RFID tag 12 and an attaching surface 13b (second surface) being fixed to an article and/or a receiving surface (front surface) of the shelf plate are formed in parallel to one the other are used. As a result, a maximum gain direction of each RFID tag attached to shelf plates facing an operator and articles on such shelf plates is oriented toward the operator. In this case, it depends on the height of the articles shelf which one of RFID tag-supporting base 13 of this embodiment and the above-described ordinary RFID tag-supporting base is used to each shelf plate between the upper-most and lower-most shelf plates 15A and 15B.

It is noted that many kinds of RFID tag-supporting bases that a prescribed angle between the RFID tag supporting surface 13a (first surface) and the attaching surface 13b (second surface) is varied may be prepared and such tag-supporting bases can selectively be used depending on the location of each self plate of the articles shelf.

In the above-described embodiment, a maximum gain direction of each RFID tag is oriented toward the center of the article shelf in a vertical direction. However, a maximum gain direction of each RFID tag may be oriented toward the center of the articles shelf in a horizontal direction.

According to the above-described embodiment, since a maximum gain direction of each RFID tag attached to the shelf plates and/or articles on the shelf plates is oriented toward the center of the articles shelf either in a vertical direction or in a horizontal direction with a simple constitution, an operator only moves the handheld interrogator within a limited area to read data from RFID tags and thus a workload for the operator can be reduced.

In the above-described embodiment, the RFID tag-supporting base 13 is a solid construction having the RFID tag supporting surface 13a and the attaching surface 13b.

It is not limited to such a solid construction of the RFID tag-supporting base 13. A rotational shaft is provided to the attaching surface in a horizontal direction, a pair of arms is extended from both ends of the RFID tag-supporting base respectively and a pair of bearings for rotating the RFID tag supporting surface is provided to the extending ends of the arms respectively.

### Second Embodiment

A second embodiment of the present invention will be described with reference to FIGS. 3 to 5.

FIG. 3 is a sectional view illustrating an RFID tag device of the second embodiment. As shown in FIG. 3, a reflection plate 18 made of metal is attached to the RFID tag supporting surface 13a (first surface) of the RFID tag-supporting base 13 and a non-metal spacer 19 is located between the reflection plate 18 and the RFID tag 12. One of side surfaces of the spacer 19 that the RFID tag 12 is attached and the other side surface thereof that the metal reflection plate 18 is attached are formed in parallel to one the other. Thus, the RFID tag 12 is supported by the receiving surface of the shelf plate 15 or an article 16 through the spacer 19, the metal reflection plate 18 and the RFID tag-supporting base 13, in order. In this structure, a thickness (T) of the non-metal spacer 19 is set to within values from λ/12 to 5λ/12 or, instead of the above, to a value that is calculated by adding (λ/2×N) to a selected value from λ/12 to 5λ/12 wherein λ is a wavelength of electromagnetic waves and N is an integer.

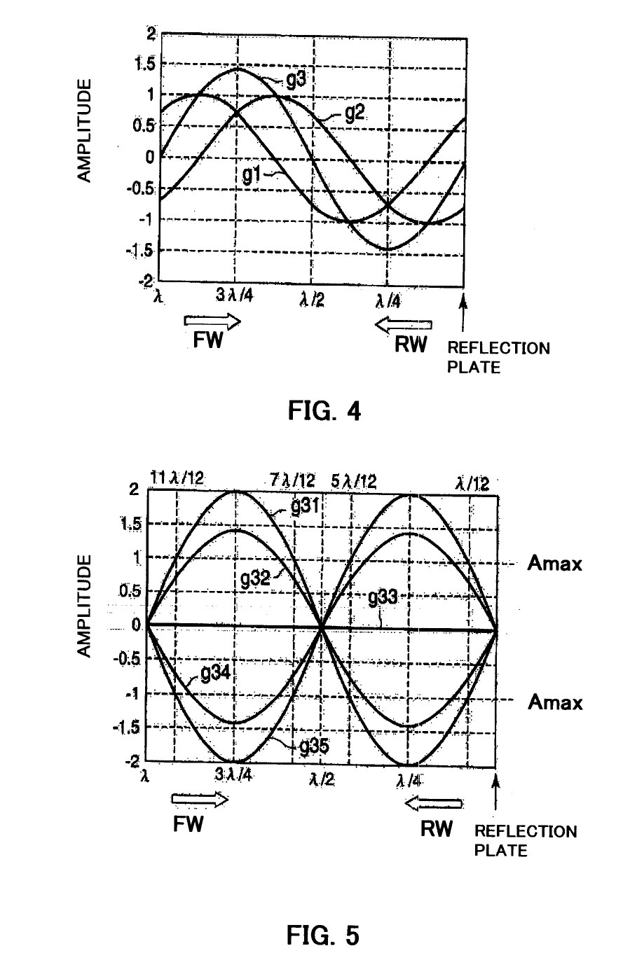

FIG. 4 is a graph showing a relationship among a forwarding wave g1 of electromagnetic waves, a reflection wave g2 thereof by a reflection plate and a composite wave g3 of the forwarding wave g1 and the reflection wave g2. In this FIGURE, a vertical axis denotes amplitude of each wave wherein maximum amplitude of the forwarding wave is one (1) and, a horizontal axis denotes a distance from the reflection plate provided that the reflection plate is located at a right-side end of the horizontal axis. The forwarding wave g1 indicates a variation pattern thereof in a phase when the forwarding wave travels in a direction (FW) from the left-side end to the right-side end of the graph in case that a phase of the forwarding wave g1 at a location apart from the reflection plate by a distance λ (one wavelength) is 45 degrees. When the forwarding wave g1 reaches the reflection plate, its polarity is reversed and then the wave travels as the reflection wave g2 in a direction (RW) from the right-side end to left in the graph. The forwarding wave g1 and the reflection wave g2 are synthesized to be the composite wave g3.

FIG. 5 is a graph indicating a variation pattern in a time-elapse of the composite wave wherein vertical and horizontal axes in this FIGURE denote the same items as that in FIG. 4. In FIG. 4, variation pattern of each wave g1, g2, g3 is indicated in case that a phase of the forwarding wave g1 at a location apart from the reflection plate by a distance λ (one wavelength) is 45 degrees. However, in FIG. 5, variation patterns of a composite wave g31 when a phase is 0 degree, a composite wave g32 when a phase is 45 degrees, a composite wave g33 when a phase is 90 degrees, a composite wave g34 when a phase is 135 degrees and a composite wave g35 when a phase is 180 degrees are indicated, respectively. A phase of electromagnetic wave advances, i.e., 0 degree→45 degrees→90 degrees→ ^{▪▪▪}, as time elapses and a time period that the phase thereof advances from 0 degree to 360 degrees is determined by a frequency of electromagnetic waves to be used. In this FIGURE, Amax denotes maximum amplitude of composite wave in positive and negative amplitudes when no reflection plate is located.

As can be seen in FIG. 5, a location that amplitude of the composite wave becomes maximum is of λ/4 and 3λ/4 from the reflection plate and amplitude of the composite wave g31 when the phase is 0 degree is double that of the forwarding wave. In general, large amplitude of electromagnetic waves is equal to strong electric field intensity. Thus, if RFID tags are arranged at either location λ/4 or 3λ/4 from the reflection plate, electromagnetic waves having a strong electric field intensity can be reflected to the RFID tags.

As can be understood from the above, one electromagnetic waves that is directly transmitted to the RFID tag 12 and another electromagnetic waves reflected by the reflection plate 18 and transmitted to the RFID tag 12 are mutually intensified and resulting in a longer communication distance between the interrogator 17 and the RFID tag 12. Accordingly, by using an RFID tag device 21 which includes the reflection plate 18 and the spacer 19, a secure radio-communication between the interrogator 17 and the RFID tags 12 can be achieved. In addition, since it can make a communication distance between the interrogator 17 and the RFID tags 12 long, a moving area of the interrogator 17 by an operator becomes small and thus a workload of the operator can be further reduced compared with the first embodiment.

In FIG. 5, a variation pattern in amplitude of each composite wave within a distance of only one-wavelength (λ) from the reflection plate is shown. However, in case that the distance from the reflection plate is more than one-wavelength, the variation pattern of one-wavelength (λ) is repeated and then a maximum amplitude of the composite wave appears at λ/4, 3λ/4, 5λ/4, 7λ/4, ▪▪▪. An electric field intensity becomes strong at an every location of λ/4×N (N is an odd number).

In this embodiment, description is made assuming that the reflection plate is a perfect reflection plate having no reflection loss. In case that the reflection plate has some reflection losses also, maximum amplitude of the composite wave appears at the same locations as described above, i.e., λ/4×N (N is an odd number). A magnitude of maximum amplitude of the composite wave, however, is smaller than that in the case of the perfect reflection plate.

In the construction shown in FIG. 3, it is preferable to set a distance between the RFID tag 12 and the reflection plate 18, i.e., a thickness of the spacer 19, to λ/4. If it is difficult to set a distance to λ/4 because of some reasons, however, a distance between the tag 12 and the plate 18 may be set to more than 3λ/4.

If a construction of the reflection plate 18 and the spacer 19 is applied only to specific RFID tags to which reading and writing are executed, an electric field only in the vicinity of such specific RFID tags can be intensified. By performing the arrangement as described above, a secure reading and writing can be executed to such specific RFID tags.

It should be noted that it is not necessarily set the location of RFID tag 12 to a location exactly at λ/4 from the reflection plate 18. As can be seen in FIG. 5, amplitude of a sine curve is not greatly varied in the vicinity of the maximum point thereof even if the distance from the reflection plate 18 is slightly changed and therefore a similar effect to RFID tags being at λ/4 from the reflection plate 18 can be performed as far as RFID tags are located in the vicinity of a distance of λ/4 from the reflection plate 18.

It should also be noted that a maximum amplitude value of electromagnetic waves within a distance from λ/12 to 5λ/12 from the reflection plate 18 is more than one (1) when the reflection plate 18 is used, on the one hand, and when the reflection plate 18 is not used, on the other hand, a maximum amplitude value of electromagnetic waves is one (1). Taking such a fact into consideration, a distance between the RFID tag 12 and the reflection plate 18 is desirably set to a value selected from a range from λ/12 to 5λ/12 to perform an effect, i.e., maximum amplitude of electromagnetic waves being more than one, by the reflection plate 18. A similar effect to the above can be obtained when a distance between the RFID tag 12 and the reflection plate 18 is set to a value selected from a range from 7λ/12 to 11λ/12. As shown in FIG. 5, an effect performed by the reflection plate 18 can be obtained if the RFID tag 12 is located at a distance obtained by adding a value selected from a range from λ/12 to 5λ/12 and ((λ/2×N (N: integer)) from the reflection plate 18. This is because that amplitude of electromagnetic waves in terms of a distance from the reflection plate 18 is periodically changed every half of the wavelength (λ/2). In addition, characteristic of the spacer 19 is also taken into consideration. If the spacer 19 is made of a dielectric substance having a specific dielectric constant (εr), a wavelength λ′ of electromagnetic waves transmitted through the spacer 19 is indicated by λ/√(εr). A wavelength (λ) in the above-description should be replaced with the wavelength (λ′) in the same description.

Furthermore, even if articles and/or an articles shelf to which the RFID tag devices 11 are attached includes moisture or metal, the RFID tags 12 of the RFID tag devices 11 affixed to such articles and/or articles shelf can carry out radio-communications with the interrogator without receiving any adverse effect by such articles and/or articles shelf. Thus, characteristics of the RFID tag 12 are not deteriorated and the communication distance (readable range) is not shortened.

### Third Embodiment

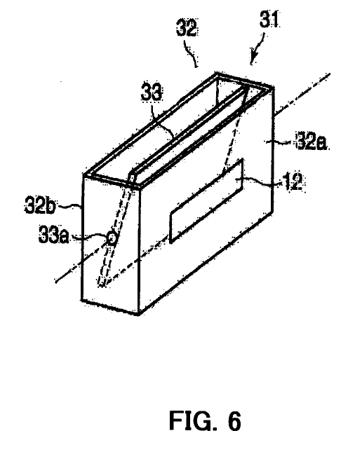

A third embodiment of the present invention will be described with reference to FIG. 6. FIG. 6 is a perspective view of an RFID tag device 31 of this embodiment.

An overall configuration of an RFID tag-supporting base 32 of the RFID tag device 31 is that an external figure of the RFID tag-supporting base 32 is in a rectangular shape and an internal body thereof is hollowed. An RFID tag 12 is attached to an RFID tag supporting surface 32a (first surface) of the REID tag-supporting base 32. An attaching surface 32b (second surface) is formed opposite to the RFID tag-supporting surface 32a. The attaching surface 32b is to be fixed to the receiving surface of the articles shelf disclosed in first and second embodiments and thus, the RFID tag device 31 is supported on the articles shelf. A rectangular shaped reflection plate 33 is provided in the hollow body portion. of the RFID tag-supporting base 32 such that the reflection plate 33 is extended in parallel to the supporting surface 32a and the attaching surface 32b and both extended ends thereof are movably supported on the RFID tag-supporting base 32 by rotational shafts 33a formed at extended ends, respectively. The reflection plate 33 is swingable by shafts 33a within the hollow body portion of the base 32 and thus the reflection plate 33 has a variable angle with respect to the RFID tag 12 attached to the supporting surface 32a of the base 32 when the reflection plate 32 is rotated, as shown in FIG. 6.

In the above-described construction, direction of electromagnetic waves radiated from the RFID tag 12 in its maximum gain direction can be varied by the reflection plate 33. This is because that an angle between the supporting surface 32a of the REID tag-supporting base 32 on which the RFID tag 12 is fixed and the reflection plate 33 is changed by the rotation of the reflection plate 33. For example, when the RFID tag device 31 is provided at a low-location or a high-location of the articles shelf compared with an usual operation range of an operator, the direction of electromagnetic waves reflected by the reflection plate 33 can be adjusted by rotating the reflection plate 33 to make an angle between the supporting surface 32a of the REID tag-supporting element 32 on which the RFID tag 12 is fixed and the reflection plate 33 large. By the rotation of the reflection plate 33, it can read the data from the RFID tags 12 of the RFID tag devices 31 positioned at such locations without greatly moving the interrogator by an operator.

It should be noted that a construction of bearing holes in a non-circular shape may be adopted to move the rotational shafts 33a in a horizontal direction between the supporting surface 32a and the attaching surface 32b. In this case, a distance between the rotational shafts 33a and the RFID tag-supporting surface 32a to which the RFID tag 12 is attached may be determined, as described in the second embodiment, within values from λ/12 to 5λ/12 or calculated by adding a value selected from a range from λ/12 to 5λ/12 and (λ/2×N) wherein λ is a wavelength of electromagnetic waves to be used and N is an integer. Such locations may be marked on the RFID tag-supporting base 32 to easily move the rotational shafts 33a to a desirable selected location. With this construction and operation, electromagnetic waves directly radiated to the RFID tag 12 and electromagnetic waves reflected by the reflection plate 33 are mutually intensified and thus a communication distance between the interrogator and the RFID tag 12 becomes long.

According to the above-described embodiment also, a secure radio-communication between the interrogator and the RFID tag can be performed. In addition, since it can make a communication distance between the interrogator and the RFID tag long, a moving distance of the interrogator by an operator is further decreased and thus a workload of an operator can be reduced.

The present invention has been described with respect to specific embodiments. However, other embodiments based on the principles of the present invention should be obvious those of ordinary skill in the art. Such embodiments are intended to be covered by the claims.

What is claimed is:

1. An RFID tag device comprising:
an RFID tag having a directivity of maximum gain of electromagnetic waves radiated therefrom in a specific direction; and
an RFID tag-supporting base configured to orient the maximum gain direction of electromagnetic waves from the RFID tag toward a desired direction, the RFID tag-supporting base having a first surface on which the RFID tag is supported and a second surface which is oppositely located with and not in parallel to the first surface.

2. The device according to claim 1 further including a reflection plate, located between the first surface and the RFID tag, which reflects the electromagnetic waves from the RFID tag and a spacer located between the reflection plate and the RFID tag, the RFID tag-supporting base, the reflection plate and the spacer being formed as a one piece.

3. The device according to claim 2, wherein the spacer includes a front and rear surfaces located in parallel to one the other, the RFID tag being attached to the front surface and the reflection plate being fixed to the rear surface.

4. The device according to claim 2, wherein a distance between the front surface and the rear surface of the spacer corresponds to a value selected from a range from λ/12 to 5λ/12 wherein λ is a wave-length of electromagnetic waves to be used.

5. The device according to claim 2, wherein a distance between the front surface and the rear surface of the spacer corresponds to a target value obtained by adding a value selected from a range from λ/12 to 5λ/12 and (λ/2×N) wherein λ is a wave-length of an electromagnetic waves to be used and N is an integer.

6. The device according to claim 3, wherein the electromagnetic waves radiated from the RFID tag is a forwarding wave, the forwarding wave reflected by the reflection plate is a reflection wave and the forwarding wave and the reflection wave form a composite wave, a distance between the front surface and the rear surface of the spacer corresponding to a value selected from a range that an amplitude of the composite wave is greater than that of the forwarding wave.

7. An RFID tag device comprising:
an RFID tag having a directivity of maximum gain of electromagnetic waves radiated therefrom in a specific direction;
an RFID tag-supporting base having a first surface on which the RFID tag is supported and a second surface which is located in parallel to the first surface so that a hollow body portion is created between the first and second surfaces; and
a reflection plate located in the hollow body portion of the RFID tag-supporting base to reflect the electromagnetic waves from the RFID tag, the reflection plate being rotatable in a direction intersecting the maximum gain direction of the electromagnetic waves from the RFID tag.

8. The device according to claim 7, wherein the RFID tag-supporting base has a pair of supporters that the reflection plate is supported to be movable toward the first surface on which the RFID tag is attached.

9. The device according to claim 7, wherein a distance between the RFID tag attached to the first surface and the reflection plate corresponds to a value selected from a range from λ/12 to 5λ/12 wherein λ is a wave-length of electromagnetic waves to be used.

10. The device according to claim 7, wherein a distance between the RFID tag attached to the first surface and the reflection plate corresponds to a target value obtained by adding a value selected from a range from λ/12 to 5λ/12 and (λ/2×N) wherein λ is a wave-length of an electromagnetic waves to be used and N is an integer.

11. The device according to claim 7, wherein the electromagnetic waves radiated from the RFID tag is a forwarding wave, the forwarding wave reflected by the reflection plate is a reflection wave and the forwarding wave and the reflection wave form a composite wave, a distance between the RFID tag attached to the first surface and the reflection plate corresponds to a value selected from a range that an amplitude of the composite wave is greater than that of the forwarding wave.

12. An articles shelf comprising:
a plurality of shelf plates in a vertical direction on which articles are placed, each shelf plate having a receiving surface at its front side; and
a plurality of RFID tag devices attached to the receiving surfaces of the shelf plates,
wherein the RFID tag device includes an RFID tag having a directivity of maximum gain of electromagnetic waves radiated therefrom in a specific direction; and an RFID tag-supporting base configured to orient the maximum gain direction of the electromagnetic waves from the RFID tag toward a desired direction, the RFID tag-supporting base having a first surface on which the RFID tag is supported and a second surface, attached to the receiving surface of the shelf plate, which is oppositely located with and not in parallel to the first surface

13. The shelf according to claim 12, wherein the plurality of shelf plates have a lower-most plate to which the RFID tag device is attached, and the first surface of the RFID tag-supporting base of the RFID tag device attached to the lower-most plate is oriented in a diagonal-upward direction.

14. The shelf according to claim 12, wherein the plurality of shelf plates have an upper-most plate to which the RFID tag device is attached, and the first surface of the RFID tag-supporting base of the RFID tag device attached to the lower-most plate is oriented in a diagonal-downward direction.
